(19) United States
(12) Patent Application Publication
(10) Pub. No.: US 2014/0024517 A1
(43) Pub. Date: Jan. 23, 2014

(54) FLOAT GLASS AND PROCESS FOR PRODUCING SAME

(71) Applicant: Asahi Glass Company, Limited, Tokyo (JP)

(72) Inventors: Yasuo HAYASHI, Tokyo (JP); Takenori MIURA, Tokyo (JP); Satoshi MIYASAKA, Tokyo (JP)

(73) Assignee: Asahi Glass Company, Limited, Tokyo (JP)

(21) Appl. No.: 14/032,531

(22) Filed: Sep. 20, 2013

Related U.S. Application Data
(63) Continuation of application No. PCT/JP2012/057058, filed on Mar. 19, 2012.

(30) Foreign Application Priority Data
Mar. 23, 2011 (JP) 2011-065086

(51) Int. Cl. C03B 18/18

(52) U.S. Cl. CPC C03B 18/18
USPC 501/11; 65/99.2; 65/99.3

(57) ABSTRACT

The present invention relates to a float glass manufactured by causing a molten glass continuously supplied onto a molten tin in a bath to flow on the molten tin toward an outlet of the bath, in which the float glass satisfies the following formula (1). According to the present invention, a high-quality float glass and a method for manufacturing the same are provided.

$$\begin{matrix}[ Math . 1 ] & \\ \frac{{\int }_{0}^{Da} ( Ca - C ( x ) ) d x}{Ca \times D} \times 100 ≦ 0.5 & ( 1 )\end{matrix}$$

### TECHNICAL FIELD

The present invention relates to a float glass and a method for manufacturing the same.

### BACKGROUND ART

A float glass is manufactured by causing a molten glass continuously supplied onto a molten tin in a bath to flow on the molten tin toward an outlet of the bath, and then being molded in a band sheet shape (for example, refer to Patent Document 1). The molten glass is cooled while it flows inside the bath in a predetermined direction, lifted from the molten tin in the vicinity of the outlet of the bath, and then formed as a float glass.

### BACKGROUND ART DOCUMENT

### Patent Document

Patent Document 1: JP-A-2009-84073

### SUMMARY OF THE INVENTION

### Problems that the Invention is to Solve

The molten glass supplied to the bath is generally manufactured by introducing powdery glass materials into a melting furnace. The melting furnace has a plurality of burners shooting out flames therein, thereby melting the glass materials with radiation heat from the flames shot from each burner.

In general, flames shot in a melting furnace are combusted by mixing heavy oil and air, however, in recent years, using natural gas instead of heavy oil and using oxygen gas instead of air have been discussed for the purpose of improving thermal efficiency and reducing the discharge amounts of CO₂ or NOₓ.

As a result of the discussion by the present inventors, when natural gas is used instead of heavy oil, and/or when oxygen gas is used instead of air, it was found that a number of defects (depressions having diameters of dozens μm to several mm) are generated on the bottom surface (that is, the surface in contact with the molten tin) of the float glass.

The present invention takes the above problem into consideration, and has an object to provide high-quality float glass and a method for manufacturing the same.

### Means for Solving the Problems

In order to solve the above-mentioned problem, the present invention provides a float glass manufactured by causing a molten glass continuously supplied onto a molten tin in a bath to flow on the molten tin toward an outlet of the bath,
wherein, when a distance from a first surface which is one surface of both main surfaces of the float glass and is positioned on a side of the molten tin in the bath to an arbitrary position in a sheet thickness direction toward a second surface which is the other surface of the of the float glass is set to be x (μm), a function of a concentration of water (mass ppm) having x as a variable is set to be C(x), a distance between the both main surfaces of the float glass is set to be D (μm), a distance from the first surface to a position in which the concentration of water is maximum in the sheet thickness direction. between the both main surfaces of the float glass is set to be Da (μm), and the concentration of water in the position of Da is set to be Ca (mass ppm),
the float glass satisfies the following formula (1):

$$\begin{matrix}[ Math . 1 ] & \\ \frac{{\int }_{0}^{Da} ( Ca - C ( x ) ) d x}{Ca \times D} \times 100 ≦ 0.5 . & ( 1 )\end{matrix}$$

In the float glass according to the above-mentioned invention, the float glass may satisfy the following formula (2):

[Math. 2]

Ca≧470 (2)

Additionally, the present invention provides a method for manufacturing a float glass, the method including causing a molten glass continuously supplied onto a molten tin in a bath to flow on the molten tin toward an outlet of the bath,
wherein an amount of water eluted from the molten glass to the molten tin in the bath is set to be 0.5% or lower of an amount of water in the molten glass immediately before flowing into the bath.

In the method for manufacturing a float glass according to the above-mentioned invention, a temperature of the molten tin in the bath and/or a temperature of the molten glass in the bath may be adjusted so that the amount of water eluted from the molten glass to the molten tin in the bath becomes 0.5% or lower of the amount of water in the molten glass immediately before flowing into the bath.

In the method for manufacturing a float glass according to the above-mentioned invention, a concentration of hydrogen gas in an atmosphere inside the bath may be adjusted so that the amount of water eluted from the molten glass to the molten tin in the bath becomes 0.5% or lower of the amount of water in the molten glass immediately before flowing into the bath.

In the method for manufacturing a float glass according to the above-mentioned invention, a concentration of water in the molten glass immediately before flowing into the bath may be 470 mass ppm or more.

### Advantage of the Invention

According to the present invention, it is possible to provide high-quality float glass and a method for manufacturing the same.

### BRIEF DESCRIPTION OF THE DRAWINGS

FIG. 1 is an illustrative diagram of a method for manufacturing a float glass according to an embodiment of the present invention, and is a plan view of an internal structure of a bath.

FIG. 2 is a cross-sectional view of a side of the bath of FIG. 1.

FIG. 3 is an illustrative diagram of a method for manufacturing a sample used to measure physical properties of the float glass.

FIG. 4 is a graph of an example of distribution of β-OH in the float glass, which is calculated based on a measurement result of micro FT-IR.

FIG. 5 is a graph of an example of distribution of the concentration of water in the float glass, which is calculated based on a measurement result of micro FT-IR.

FIG. 6 is a graph of an example of distribution of counted ratios (hydrogen atoms/silicon atoms) in the float glass based on a measurement result of SIMS.

FIG. 7 is a graph of an example of distribution of the concentration of water in the float glass, which is calculated based on a measurement result of micro FT-IR and a measurement result of SIMS.

### MODE FOR CARRYING OUT THE INVENTION

Hereinafter, embodiments for implementing the present invention will be described with reference to drawings. The present invention is not limited to the embodiments to be described below. Various modifications and substitutions can be added to the following embodiments without departing from the scope of the present invention.

The type of a float glass of the present embodiment is, for example, soda-lime glass, but the type of float glass of the present invention is not limited, and may be, for example, an alkali-free glass.

### Float Glass

A float glass is manufactured by causing a molten glass continuously supplied onto a molten tin in a bath to flow on the molten tin toward an outlet of the bath. The molten glass is cooled while it flows inside the bath in a predetermined direction, lifted from the molten tin in the vicinity of the outlet of the bath, and then formed as a float glass.

After the float glass is drawn from the outlet of the bath, the glass is transported to an annealing furnace so as to be gradually cooled. Next, both of the edge parts (so-called ear parts) of the float glass are cut out. Then, predetermined dimensions of the float glass is cut by a cutting machine, and then released as a product. Before being released as a product, at least one of both main surfaces of the float glass (the bottom surface (first surface) which was in contact with the molten tin and the top surface on the opposing side of the bottom surface (second surface)) may be polished if necessary. Note that the bottom surface and the top surface are not polished in the present embodiment.

Meanwhile, with regard to the concentration of water in the float glass in the vicinity of the bottom surface, the concentration of water tends to gradually decrease toward the bottom surface. This is because the water contained in the molten glass in the bath is eluted to the molten tin via the bottom surface. On the other hand, since the concentration of water contained in the float glass at a position located sufficiently apart from the bottom surface toward the top surface, for example, around the middle point between the bottom surface and the top surface, is substantially constant, the water does not come out.

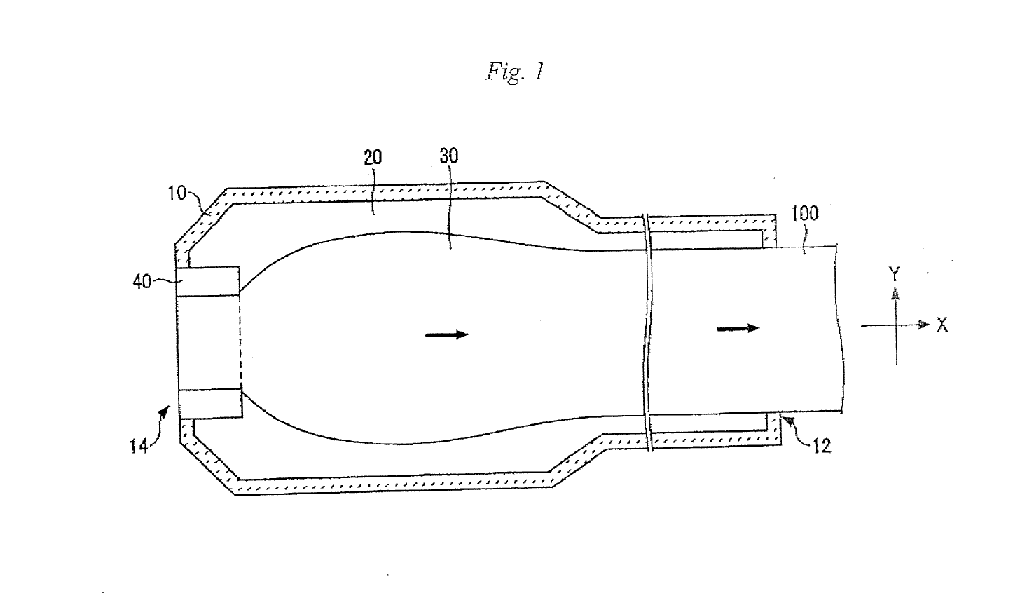

Thus, when cuboid float glass having a length of 1 cm and a width of 1 cm is manufactured, if the amount of water contained in molten glass immediately before flowing iota the bath (hereinafter, also referred to as an “initial amount”) is set to be A1(g), A1 is calculated from the following formula (3), It should be noted that the “length” means a dimension in the direction X of FIG. 1, and the “width” means a dimension in the direction Y of FIG. 1.

$$\begin{matrix}[ Math . 3 ] & \\ A 1 = Ca \times D \times \frac{ρ}{{10}^{4}} & ( 3 )\end{matrix}$$

In the formula (3), D denotes the distance between both main surfaces of the float glass (in other words, the sheet thickness of the float glass) (μm), Ca denotes the concentration of water at a position between both main surfaces of the float glass in which the concentration of water becomes maximum (mass ppm) (in other words, the concentration of water that is substantially constant at a position located sufficiently apart from the bottom surface toward the top surface), and p denotes the density of the float glass (g/cm³). A measuring method of the concentration of water Ca will be described later. It should be noted that, in the formula (3), 10⁴ is for converting the unit of D “μm” into “cm.”

In addition, when the cuboid float glass having a length of 1 cm and a width of 1 cm is manufactured, if the amount of water eluted from the molten glass to the molten tin (hereinafter, also referred to as an “amount of elution”) is set to be A2(g), A2 is calculated from the following formula (4).

$$\begin{matrix}[ Math . 4 ] & \\ A 2 = {\int }_{0}^{Da} ( Ca - C ( x ) ) \frac{ρ}{{10}^{4}} d x & ( 4 )\end{matrix}$$

In the formula (4), x denotes the distance (μm) from the first surface (bottom surface) which is one surface of both main surfaces of the float glass and is positioned on a side of the molten tin in the bath to an arbitrary position in the sheet thickness direction toward the second surface (top surface) which is the other surface, C(x) denotes a function of the concentration of water (mass ppm) having x as a variable, and Da denotes the distance from the first surface (bottom surface) to a position in which the concentration of water is the maximum in the sheet thickness direction between the both main surfaces of the float glass. A measuring method of the function C(x) of the concentration of water will be described later. In the formula (4), x, D, Ca, and ρ have the same meaning as those in the formula (3). It should be noted that, in the formula (4), 10⁴ is for converting the unit of x “μm” into “cm.”

The float glass of the present embodiment is characterized in that A calculated from the following formula (5) is 0.5% or lower. A denotes a ratio of the amount of elution A2 to the initial amount A1 (%).

$$\begin{matrix}[ Math . 5 ] & \\ A = \frac{A 2}{A 1} \times 100 = \frac{{\int }_{0}^{Da} ( Ca - C ( x ) ) d x}{Ca \times D} \times 100 & ( 5 )\end{matrix}$$

Since a float glass having a ratio A being 0.5% or lower, which will be described later in detail, has a bottom surface with little defects, the float glass has excellent advantages in quality and manufacturing cost. The ratio A is preferably 0.47% or lower, and more preferably 0.45% or lower.

As the initial amount A1 increases, the amount of elution A2 increases, accordingly, defects easily arises, and thus, in such a case, an effect of the present invention is noticeable. Thus, the present invention is preferable when the concentration of water Ca that serves as the index of the initial amount A1 is 470 (mass ppm) or more, since a noticeable effect can be obtained, and is particularly preferable when the concentration of water is 490 (mass ppm) or more. In addition, when the values are expressed for β-OH, to be described later, that serves as the index of the concentration of water Ca with regard to soda-lime glass, the invention is preferable when the value is 0.26 mm⁻¹ or more, and is particularly preferable when the value is 0.27 mm⁻⁴ or more.

There is no limitation on the thickness of a float glass product, however, the thickness is, for example, 0.1 mm to 25 mm, and preferably 0.5 mm to 25 mm.

High quality of a float glass with the above-described concentration of water is obvious based on the manufacturing method. Hereinafter, the manufacturing method will be described.

### Manufacturing Method of Float Glass

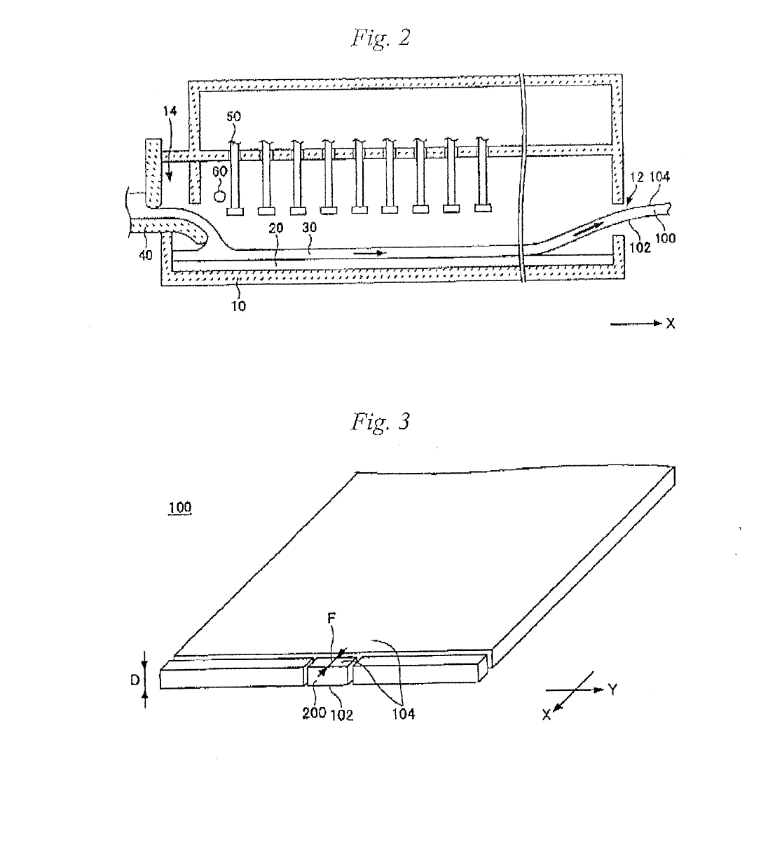

FIG. 1 is an illustrative diagram of a manufacturing method of a float glass according to an embodiment of the present invention, showing a plan view of an internal structure of a bath. FIG. 2 is a cross-sectional view of a side of the bath of FIG. 1.

A float glass 100 is manufactured by causing a molten glass 30 continuously supplied onto a molten tin 20 in a bath 10 to flow on the molten tin 20 toward an outlet 12 of the bath 10, and then being molded in a band sheet shape. The molten glass 30 is cooled while flowing inside the bath 10 in the direction X, lifted from the molten tin 20 in the vicinity of the outlet 12 of the bath 10, and then formed as the float glass 100.

The float glass 100 is drawn from the outlet 12 of the bath 10, transported to an annealing furnace so as to be gradually cooled. Next, both of the edge parts (so-called ear parts) of the float glass 100 are cut out. Then, predetermined dimensions of the float glass is cut by a cutting machine, and then released as a product. Before being released as a product, at least one of both main surfaces of the float glass 100 (a bottom surface 102 which was in contact with the molten tin 20 and a top surface 104 on the opposing side of the bottom surface 102) may be polished if necessary. It should be noted that the bottom surface 102 and the top surface 104 are not polished in the present embodiment.

In the bath 10, a spout lip 40, a plurality of heaters 50, a gas supply pipe 60, and the like are provided. The spout lip 40 is provided in the vicinity of the inlet 14 of the bath 10, serving as a supply path for supplying the molten glass 30 to the bath 10. The spout lip 40 is connected to a melting furnace for melting powdery glass materials, For this reason, the temperature of the molten glass 30 flowing into the bath 10 can be adjusted according, to the output of a burner provided in the melting furnace, the output of the heaters provided in the vicinity of the spout lip 40, or the like.

The plurality of heaters 50 are suspended from the ceiling of the bath 10 as shown in, for example, FIG. 2, for heating inside the bath 10. The plurality of heaters 50 arc provided in a matrix state, for example, in the flowing direction (direction X) and the width direction (direction Y) of the molten glass 30. Distribution of temperatures of the molten tin 20 and the molten glass 30 inside the bath 10 can be adjusted according to the output of the plurality of heaters 50, and the like, and is set so that the temperatures become lower in the direction of the outlet 12 of the bath 10.

The gas supply pipe 60 supplies reducing gas into the bath 10, and for example, supplies reducing, gas into the bath 10 from a side wall of the bath 10 as shown in FIG. 2, or from the ceiling of the bath 10. Reducing gas includes nitrogen (N²) gas, hydrogen (H₂) gas, and the like, and is blown into the bath 10 after being pre-heated to a predetermined temperature, The concentration of hydrogen gas is preferably 15 volume % or lower. Hydrogen gas suppresses oxidization of the molten tin 20 by reacting with oxygen gas incorporated into the bath 10. The concentration of hydrogen in the atmosphere inside the bath 10 can be adjusted according to the output of the gas supply pipe 60, a change in the type of reducing gas, or the like.

The concentration of water inside the molten glass 30 flowing into the bath 10 can be determined based on the concentration of water in the atmosphere inside the melting furnace, or the like. As the concentration of water in the atmosphere inside the melting furnace increases, the concentration of water inside the molten glass 30 in the melting furnace increases, and thus, the concentration of water inside the molten glass 30 flowing into the bath 10 from the melting furnace increases.

In recent years, for the purpose of improving thermal efficiency in a melting furnace, in addition, of reducing the discharge amounts of CO₂ and NOₓ, using natural gas instead of heavy oil and using oxygen gas instead of air in order to shoot flames in the melting furnace have been discussed. When natural gas is used instead of heavy oil, and/or oxygen gas is used instead of air, the concentration of water in the atmosphere inside the melting furnace increases, and accordingly, the amount of water in the molten glass 30 immediately before flowing into the bath 10 (in other words, the above-described initial amount A1) increases. When the initial amount A1 increases, the amount of water eluted from the molten glass 30 to the molten tin 20 in the bath 10 (in other words, the above-described amount of elution A2) easily increases.

In the present embodiment, the amount of elution A2 is set to be 0.5% or lower (preferably 0.47% or lower, and more preferably 0.45% or lower) of the initial amount A1. Accordingly, the amount of gas components (for example, the amount of hydrogen and the amount of oxygen) dissolved in the molten tin 20 can be suppressed so as to be smaller than the saturation amount thereof. The saturation mount is determined based on the temperature of the molten tin 20, and as the temperature of the molten tin 20 becomes lower, the saturation amount becomes lower. Particularly, a ratio of the amount of production of float glass per day (ton/day) with respect to the molten tin 20 (ton) is preferably 300% to 600%.

According to the present embodiment, since the amount of gas components dissolved in the molten tin 20 can be suppressed to he lower than the saturation amount, precipitation of gas components from the molten tin 20 due to oversaturation can be suppressed in the course of flowing the molten tin 20 along the molten glass 30 in the bath 10 in the direction X and cooling. Thus, occurrence of defects (depressions having diameters of dozens μm to several mm) on the contact surface of the molten glass 30 with the molten tin 20 in a midstream or a down-stream region in the bath 10 can be suppressed, and thus, the quality of the bottom surface 102 of the float glass 100 can be improved.

As the initial amount A1 increases, the amount of elution A2 increases, thus, defects easily occurs, and thus, the effect of the present invention is noticeable in such a case. Thus, the present invention is preferable since the effect thereof is noticeable when the concentration of water Ca that serves as an index of the initial amount A1 is 470 (mass ppm) or more, and is particularly preferable when the concentration of water is 490 (mass ppm) or more. In addition, when the values are expressed for β-OH, to be described later, that serves as the index of the concentration of water Ca with regard to soda-lime glass, the invention is preferable when the value is 0.26 mm⁻¹ or more, and is particularly preferable when the value is 0.27 mm⁻¹ or more.

In the present embodiment, the temperature of the molten tin 20 in the bath 10 and/or the temperature of the molten glass 30 in the bath 10 is/are adjusted so that the amount of elution A2 becomes 0.5% or less of the initial amount A1 (preferably 0.47% or less, and more preferably 0.45% or less). Such adjustment of temperature is effective when it is performed in an up-stream region in the bath 10. This is because the amount of gas components emitted from the molten tin 20 due to oversaturation in the midstream or the down-stream region in the bath 10 is determined based on the amount of gas components dissolved in the molten tin 20 in the up-stream region in the bath 10. Here, the “up-stream region in the bath 10” refers to all regions on the up-stream side of the position 160 inches (equivalent to 406 cm) apart from the end (down-stream end) of the spout lip 40 in the direction X.

When the temperature of the molten tin 20 in the up-stream region in the bath 10 is set to be T1 (° C.), as the temperature T1 becomes lower, the amount of saturated gas components dissolved in the molten tin 20 decreases, and the reaction speed of the molten tin 20 and the molten glass 30 becomes slower, and accordingly, the amount of elusion decreases.

The temperature T1 can be adjusted according to the output of the burner shooting flames in the melting furnace, the output of the heater provided in the vicinity of the spout lip 40, or the output of the heaters 50 provided in the bath 10. In addition, the temperature can also be adjusted according to the installation of a cooling source (cooler).

In addition, when the temperature of the molten glass 30 in the up-stream region in the bath 10 is set to be T2 (° C.), as the temperature T2 becomes lower, the reaction speed of the molten glass 30 and the molten tin 29 becomes slower, and accordingly, the amount of elution decreases.

The temperature T2 is set according to the type, thickness, or the like of the float glass 100. The temperature T2 can be adjusted according to the output of the burner shooting flames in the melting furnace, the output of the heater (for example, a platinum heater) provided in the vicinity of the snout lip 40, or the output of the heaters 50 provided in the bath 10. In addition, the temperature can also be adjusted according to the installation of a cooling source (cooler).

In addition, the concentration of hydrogen gas in the atmosphere in the bath 10 may be adjusted so that the amount of elution A2 becomes 0.5% or lower of the initial amount A1 (preferably 0.47% or lower, and more preferably 0.45% or lower). When the concentration of hydrogen gas in the atmosphere in the up-stream region in the bath 10 is set to be U (volume %), as the concentration of hydrogen gas U becomes higher, the concentration of hydrogen gas dissolved in the molten tin 20 increases, and accordingly, the amount of elution easily decreases.

The concentration of hydrogen gas U is set according to the type, the thickness or the like of the float glass 100. In the case of soda-lime glass, for example, the concentration of hydrogen gas U is preferably 5 (volume %) or more, and more preferably 10 (volume %) or more. It should be noted that the concentration of hydrogen gas U is preferably 15 (volume %) or lower in light of cost.

The concentration of hydrogen gas U can be adjusted according to the output of the gas supply pipe 60 that supplies reducing gas into the bath 10, or the type of the reducing gas.

It should be noted that, in the present invention, besides the above, for example, an additive may be added to the molten tin 20 in order to suppress the amount of elution to be low.

### Measuring Method of a Ratio of the Amount of Elution to the Initial Amount

A ratio of the amount of elution A1 to the initial amount A1 is measured from distribution of concentrations of water contained in the float glass 100 as a product. When the ratio of the amount of elution A2 to the initial amount A1 is set to be A(%), the ratio A is calculated from the above-described formula (5).

In order to calculate the ratio A, the concentration of water Ca and the function C(x) of the concentration of water are obtained, A sample 200 used to obtain the function C(x) of the concentration of water is prepared by slicing the sample from an end of the float glass 100 with the non-polished bottom surface 102 so as to have the sheet thickness F and then cutting out the sample from the center of the float glass 100 in the width direction (direction Y) as shown in FIG. 3. The sheet thickness direction of the sample 200 is orthogonal to the sheet thickness direction of the float glass 100, and the outer circumferential surfaces of the sample 200 include the bottom surface 102 and the top surface 104 of the float glass 100. It should be noted that a sample used to obtain the concentration of water Ca is prepared by polishing the bottom surface 102 and the top surface 104 of the float glass 100, and then chipping out the portion having the maximum concentration of water (portion in which the concentration of water is constant).

The concentration of water Ca is obtained by measuring an IR spectrum at a position in which the concentration of water (concentration of water before the correction) obtained by using a micro FT-IR (Fourier Transform Infrared Spectrophotometer), to be described later, is at the maximum level (substantially constant) using a macro FT-IR. Specifically, based on the measurement result of the IR spectrum, a value of μ-OH Ea (mm⁻¹)serving as an index of the concentration of water is calculated from the following formula (6), Next, Ca is calculated by applying the calculated value Ea to the following formula (7).

$$\begin{matrix}[ Math . 6 ] & \\ Ea = \frac{{10}^{3}}{F} \times {log}_{10} ( \frac{B 1}{B 2} ) & ( 6 )\end{matrix}$$

In the formula (6), P denotes a sheet thickness (pm) of the sample 200, and for example, P=100 (μm). In addition, in the formula (6), BI denotes a transmittance (%) of the sample 200 in a reference wavenumber of 4000/cm, and B2 denotes a minimum transmittance (%) of the sample 200 around a hydroxyl group absorption wavenumber of 3600/cm. It should be noted that, in the formula (6), 10³ is used to convert the unit of F “μm” into “mm.”

$$\begin{matrix}[ Math . 7 ] & \\ Ca = \frac{Ea}{ɛ} \times \frac{G}{ρ} \times {10}^{4} & ( 7 )\end{matrix}$$

In the formula (7), G denotes the molar mass of water (G=18 (g/mol)), ε denotes a molar extinction coefficient of glass (L/mol·cm), and ρ denotes density of glass (g/cm³). ε and ρ differ depending on the type of glass, but in the case of soda-lime glass, ε=40 (L/mol·cm), and ρ=2.5 (g/cm³) in general. It should be noted that, in the formula (7), 10⁴ is used to convert the unit of Ea “mm⁻¹” to “cm⁻¹,” and is obtained by multiplying “10⁻²” that is used to convert the unit of ε “L/mol·cm” into “cm²/mol” by “10⁶” that is used to express the concentration of water Ca with “mass ppm.”

The function C(x) of the concentration of water is calculated based on the measurement result of the micro FT-IR and the measurement result of a Secondary Ion Mass Spectrometer (SIMS).

Specifically, first, the IR spectrum of the sample 200 is measured at an interval of 10 μm in the direction from the bottom surface 102 to the top surface 104 using the micro FT-IR, β-OH is calculated at each measurement point in the same manner as described above, and the result is converted into the concentration of water. The measurement start point is set to be the position of x=50 (μm) in consideration of the performance of the micro FT-IR. In addition, the measurement end point may be the position in which the concentration of water is constant, and is set to be the position, for example, of x=1000 (μm). The measurement and point may be the position of approximately x=D/2 (μm) (in other words, the center of the sheet thickness). It should be noted that the concentration of water becomes higher in the direction from the bottom surface 102 to the top surface 104, and when there is no position in which the concentration of water is substantially constant, for example, in the case of thin float glass having a sheet thickness of 0.1 mm, the measurement end point may be the position in which the concentration of water is the maximum, in other words, a position in the vicinity of the top surface 104.

The β-OH obtained by using the micro FT-IR is corrected with the β-OH obtained by using the macro FT-IR described above in order to increase reliability. When the β-OH at each measurement point before the correction is set to be B, the β-OH at the measurement end point before the correction or the average value of the β-OH at each measurement point at which the concentration of water is substantially constant is set to be B1, and the β-OH obtained by using the macro FT-IR is set to be B2, β-OH at each measurement point after the correction is expressed as B×B2/B1.

In addition, the concentration of water obtained by using the micro FT-IR is also corrected with β-OH obtained by using the macro FT-IR described above in the same manner.

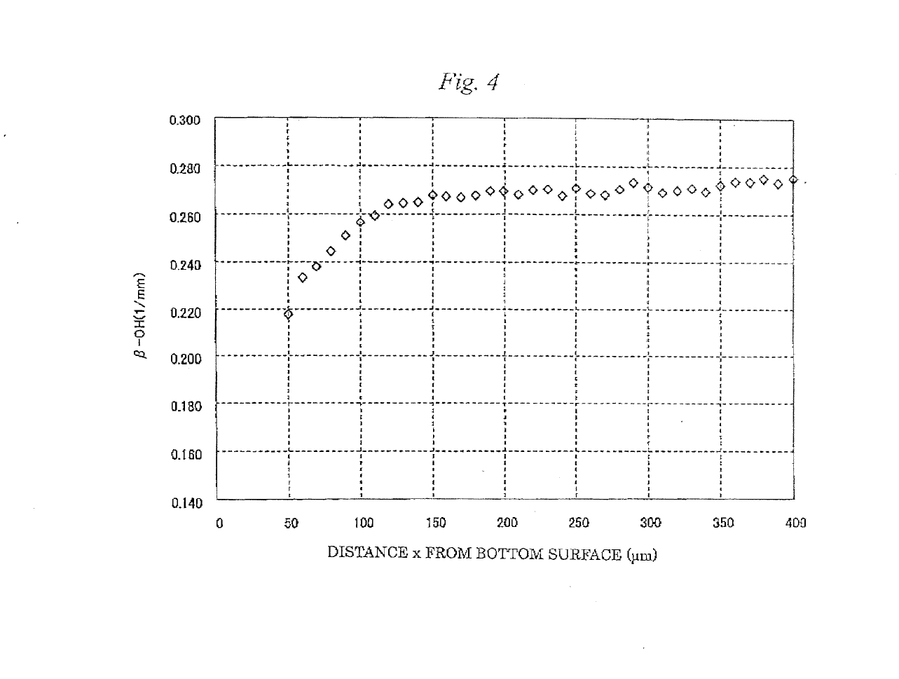

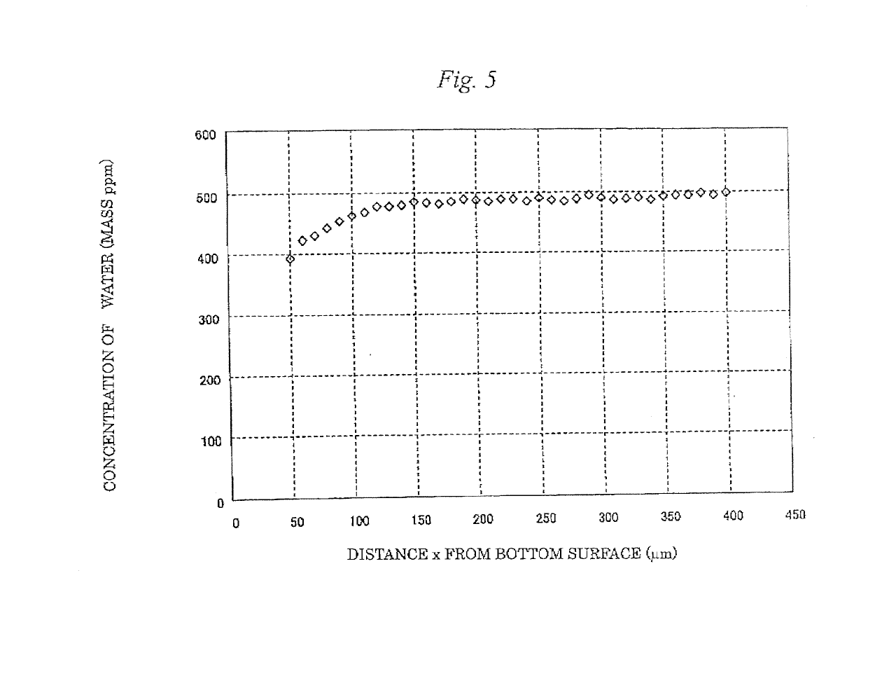

An example of distribution of β-OH after the correction obtained by using the micro FT-IR is illustrated in FIG. 4, and an example of distribution of concentrations of water after the correction is illustrated in FIG. 5. It was found from FIGS. 4 and 5 that the concentration of water is substantially constant in positions sufficiently apart from the bottom surface 102, and water is little eluted in the molten tin 20. In addition, it was found from FIGS. 4 and 5 that the concentration of water becomes lower toward the bottom surface 102 in the vicinity of the bottom surface 102, and water is eluted to the molten tin 20.

Next, a count ratio of hydrogen (H) atoms and silicon (Si) atoms (hydrogen atoms/silicon atoms) in the sample 200 is measured at an interval of 0.02 μm in the direction from the bottom surface 102 to the top surface 104 of the float glass 100 using SIMS. The measurement start point is set to be the position of x=0.03 (μm). In addition, the measurement end point is set to be the position of x=36 (μm).

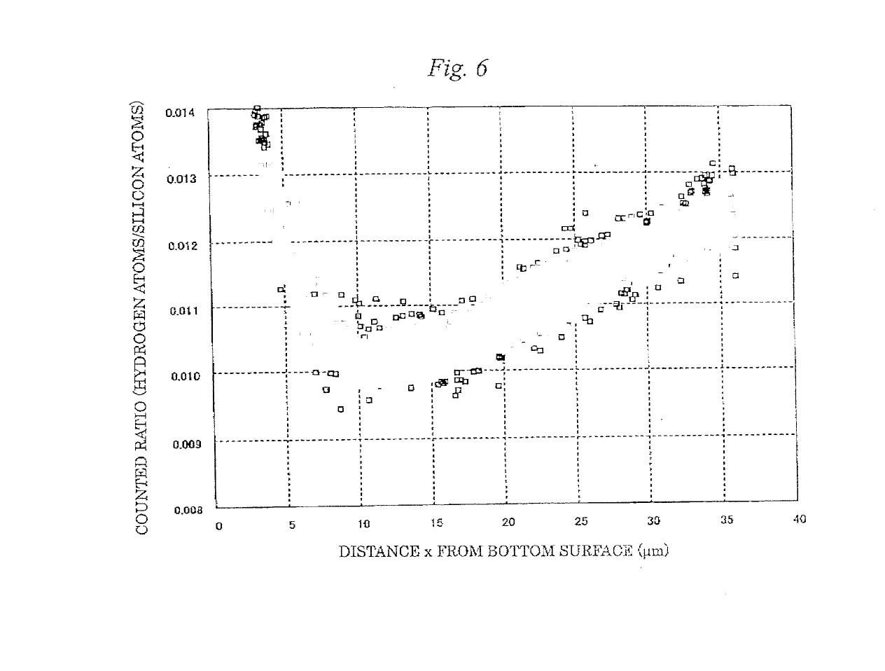

An example of distribution of the count ratio (hydrogen atoms/silicon atoms) in the float glass 100 based on the measurement result of SIMS is illustrated in FIG. 6. As is clear from FIG. 6, the count ratio (hydrogen atoms/silicon atoms) becomes lower toward the bottom surface 102 in a region 10 μm or more apart from the bottom surface 102, and thus, it was found that water is eluted to the molten tin 20.

As is clear from FIG. 6, however, the count ratio (hydrogen atoms/silicon atoms) becomes higher toward the bottom surface 102 in a region less than 10 μm apart from the bottom surface 102. It is presumed that this is because protons (hydrogen ions) separated from water vapor adhere to the bottom surface 102 of the float glass 100 and undergo ion exchange with sodium (Na) ions in the glass in the annealing furnace, Thus, the count ratio (hydrogen atoms/silicon atoms) at each measurement point less than 13 μm apart from the bottom surface 102 is not appropriate as an index indicating the amount of water, and excluded from the following process.

Next, each value H of the count ratios (hydrogen atoms/silicon atoms) at each measurement point is applied to the following formula (8), and the result is converted into a value E of β-OH(mm⁻¹).

$$\begin{matrix}[ Math . 8 ] & \\ E = \frac{H}{Ha} \times Ea & ( 8 )\end{matrix}$$

In the formula (8), Ea denotes the value of β-OH (mm⁻¹) at the position in which the concentration of water is the maximum (position sufficiently apart from the bottom surface 102 in which the concentration of water is substantially constant), and is calculated from the formula (6) based on the measurement result of the macro FT-IR as described above.

In the formula (8), Ha denotes the value of the count ratio (hydrogen atoms/silicon atoms) at the position in which the concentration of water is the maximum (position sufficiently apart from the bottom surface 102 in which the concentration of water is substantially constant), and measured using SIMS. The number of measurement points of SIMS is set to be 1200, and the average value of the measurement results thereof is set to be Ha. Ea and Ha differ depending on the type of glass, but in the case of soda-lime glass, for example, Ea=0.271 (mm⁻¹) and Ha=0.0173.

Next, each value E of β-OH (mm⁻¹) calculated from the formula (8) is applied to the formula (9) described below, and the result is converted into a value J of the concentration of water (mass ppm).

$$\begin{matrix}[ Math . 9 ] & \\ J = \frac{E}{ɛ} \times \frac{G}{ρ} \times {10}^{4} & ( 9 )\end{matrix}$$

In the formula (9), G, ε, and ρ have the same meanings and the same values as those in the formula (7). In addition, in the formula (9), 10⁴ is used to convert the unit of E “mm⁻¹” to “cm⁻¹,” and is obtained by multiplying “10⁻²” that is used to convert the unit of a “L/mol·cm” into “cm²/mol” by “10⁶” that is used to express the concentration of water J with “mass ppm.”

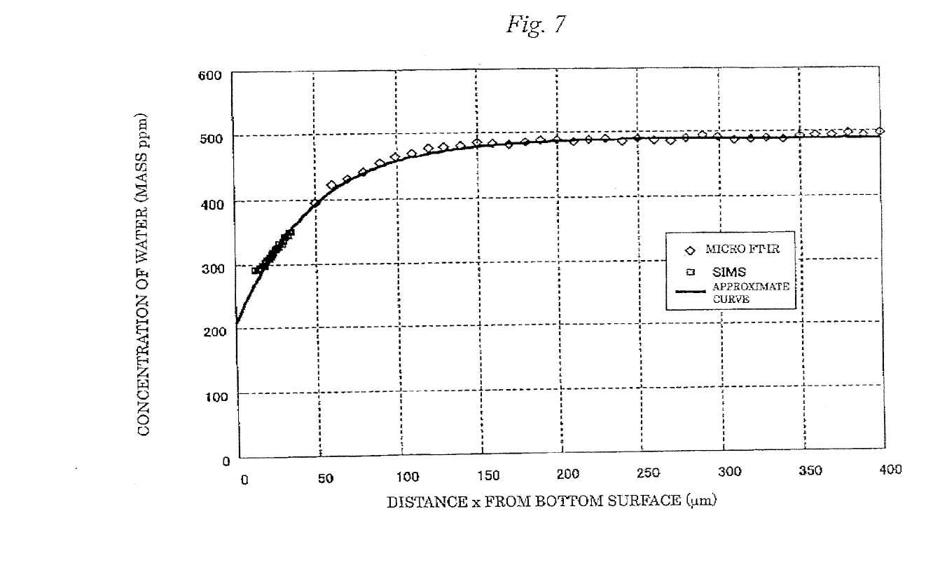

Next, by combining the concentration of water after the correction obtained by using the micro FT-IR with the concentration of water obtained by using SIMS, distribution of the concentration of water in the float glass 100 is obtained. The obtained result is shown in FIG. 7. In FIG. 7, “⋄” indicates the values of the concentration of water after the correction obtained by using the micro FT-IR, and “□” indicates the values of the concentration of water obtained by using SIMS. Note that, since the values of the concentration of water obtained by using SIMS has a large error in FIG. 7, the values are set by movement average values at 10 points. It was found from FIG. 7 that the values of the concentration of water after the correction obtained by the micro FT-IR match the values of the concentration of water obtained by SIMS.

Next, variable parameters in the following formula (10) are obtained using a least squares method so that distribution of the concentrations of water in the float glass 100 has a minimum difference with the following formula (10) that is a model formula of the function C(x) of the distribution of the concentrations.

[Math, 10]

C(x)=Ca−K×exp(−L×x) (10)

In the formula (10), Ca denotes the value of the concentration of water (mass ppm) at the position in which the concentration of water is the maximum (position sufficiently apart from the bottom surface 102 in which the concentration of water is substantially constant), and is calculated from the formula (6) and the formula (7) based on the measurement result by the macro FT-IR as described above.

In addition, in the formula (10), K and L are variable parameters. In FIG. 7, an approximate curve of K=282 (mass ppm) and L=0.021 (μm⁻¹) is indicated by a solid line.

In this manner, after C(x) and Ca are determined, A is calculated based on the formula (5). At this moment, integration according to sectional mensuration is performed based on the following formula (11).

$$\begin{matrix}[ Math . 11 ] & \\ {\int }_{0}^{Da} ( Ca - C ( x ) ) d x = {\sum }_{l = 0}^{n} \{ ( Ca - Ci ) \times M \} & ( 11 )\end{matrix}$$

In the formula (11), Da denotes a distance (μm) from the bottom surface 102 to the position in which the concentration of water is the maximum in the sheet thickness direction between both main surfaces of the float glass. M denotes an interval (μm) of measurement points of the micro FT-IR, which is M=10. In addition, i denotes an integer from 0 to n, n denotes the number of measurement points of the micro FT-IR, and Ci denotes C(x) when x=i×F. It should be noted that a value of n is not limited as long as it is set so that the concentration of water is kept to be substantially constant at the point of x=i×F and the periphery thereof.

It should be noted that, in the above description, the float glass 100 having the non-polished bottom surface 102 is exemplified, but the bottom surface 102 of the float glass 100 may be polished. If polishing is performed on a float glass to be used in a glass substrate for liquid crystal, the amount of elution as much as a polished sheet thickness is trivial and can be ignored, and thus the concentration of water as described above can be obtained. In addition, in the case of a float glass in use of which the bottom surface 102 is polished to the extent that the amount of elution of the polished sheet thickness cannot be ignored, the concentration of water is obtained in such a way that an approximate expression is obtained as described above, the approximate expression is extended for the polished sheet thickness, and then the amount of elution as much as the removed sheet thickness is estimated.

### EXAMPLES

Hereinbelow, the present invention will be described in detail using examples, and the like, however, the present invention is not limited to the examples.

### Example 1 and Comparative Example 1

In Example 1 and Comparative Example 1, float glasses having a product thickness of 5 mm were manufactured by causing a molten glass to flow on a molten tin toward an outlet of a bath in the same manner except that temperatures T1 and T2 of the molten tin and the molten glass in an up-stream region of the bath were changed. The type of the float glasses were set to be soda-lime glass.

Samples were cut out from the produced float glasses using the above-described method, and physical properties of the samples were measured using the following devices under the following measurement conditions.

### Macro FT-IR

Device: FT-IR-8400 manufactured by Shimadzu Corporation

Number of scanning times: 70

Spectral resolution: 4 cm⁻¹

### Micro FT-IR

Device: Micro FT-IR Nicolet iN10 manufactured by Thermo Fisher Scientific Inc.

Detector: Cooling type

Number of scanning times: 128

Spectral resolution: 16 cm⁻¹

Aperture: 10 μm for width, 150 μm for height, 0° for angle

### SIMS

Device: ADEPT 1010 manufactured by ULVAC-PHI

Primary ion Cs+, negative ion detected

Accelerating voltage: 5 kV

Beam current: 1 μA

Raster size: 200×200 μm

Sample angle: 60°

Based on the measurement results, the value A(%) of the ratio of the amount of elution A2 to the initial amount A1, the value Ea (mm⁻¹) of β-OH at the position sufficiently apart from the bottom surface, in which the concentration of water is substantially constant, in this case, at the position 1000 μm apart from the bottom surface, and the value Ca (mass ppm) of the concentration of water at the same position 1000 μm apart from the bottom surface were calculated in the above-described method. In addition, the presence or absence of defects (depressions having a short diameter of 1.5 mm or greater) on the bottom surface of each float glass produced was visually checked. The results and the molding conditions of the float glass are shown in Table 1.

TABLE 1

| | | | Com- |
|---|---|---|---|
| | | | parative |
| | | Example 1 | Example 1 |
| Molding | Product thickness (mm) | 5 | 5 |
| conditions | Temperature T1 (° C.) | 1004 | 1051 |
| | Temperature T2 (° C.) | 1030 | 1060 |
| | Concentration of hydrogen gas U | 3 | 3 |
| | (volume %) | | |
| Results | Ratio A of the amount of elution to the | 0.45 | 0.62 |
| | initial amount (%) | | |
| | β-OH Ea at the sheet thickness center | 0.27 | 0.27 |
| | (mm⁻¹) | | |
| | Concentration of water Ca at the sheet | 486 | 486 |
| | Thickness center (mass ppm) | | |
| | Presence or absence of defects | Absent | Present |

The T1 in Table 1 is data measured on the point 95 inches (equivalent to 240 cm) away from the end of a spout lip in the direction X, and on a bare surface of tin without the molten glass in the direction Y. The T2 and U respectively indicate data measured on the point 95 inches (equivalent to 240 cm) away from the end of a spout lip in the direction X, and a center point of the direction Y in an up-stream region in the bath. It should be noted that the T1 and T2 are data measured by a radiation thermometer.

In the case of the product thickness of 5 mm, it was found from Table 1 that, by setting the T1 to be 1010 (° C.) or less, A becomes 0.5(%) or lower, and defects on the bottom surface disappear.

### Example 2 and Comparative Examples 2 to 3

In Example 2 and Comparative Examples 2 to 3, float glasses were manufactured in the same manner as in. Example 1 except that the temperatures T1 and T2 of the molten tin and the molten glass in the up-stream region in the bath were changed, and the product thicknesses of the float glasses were set to be 3 mm.

Samples were cut out from the produced float glasses in the same manner as in Example 1, and physical properties of the samples were measured. In addition, based on the measurement result, A, Ea, and Ca were calculated. Further, the presence or absence of defects (depressions having a short diameter of 1.5 mm or greater) on the bottom surface of each float glass produced was visually checked. The results and molding conditions of the float glasses are shown in Table 2.

TABLE 2

| | | | Comparative | Comparative |
|---|---|---|---|---|
| | | Example 2 | Example 2 | Example 3 |
| Molding | Product thickness (mm) | 3 | 3 | 3 |
| conditions | Temperature T1 (° C.) | 992 | 1006 | 998 |
| | Temperature T2 (° C.) | 1020 | 1035 | 1025 |
| | Concentration of hydrogen gas U | 3 | 3 | 3 |
| | (volume %) | | | |
| Results | Ratio A of the amount of elution to the | 0.41 | 0.76 | 0.51 |
| | initial amount (%) | | | |
| | β-OH Ea at the sheet thickness center | 0.27 | 0.27 | 0.27 |
| | (mm⁻¹) | | | |
| | Concentration of water Ca at the sheet | 486 | 486 | 486 |
| | thickness center (mass ppm) | | | |
| | presence or absence of defects | Absent | Present | Present |

The T1, T2, and U in Table 2 are data measured at the same position as the T1, T2, and U of Table 1.

In the case of the product thickness of 3 mm, it was found from Table 2 that, by setting T1 to be 995(° C.) or lower, A becomes 0.5(%) or lower, and defects on the bottom surface disappear.

The present invention has been described in detail or with reference to specific embodiments, however, it is obvious to those skilled in the art that the present invention can be variously modified and changed without departing from the gist and the scope of the present invention.

The present application is based on Japanese Patent Application No, 2011-065086 filed on Mar. 23, 2011, the content of which is incorporated herein by reference.

### INDUSTRIAL APPLICABILITY

According to the present invention, it is possible to provide high-quality float glass and a method for manufacturing the same.

### DESCRIPTION OF REFERENCE NUMERALS AND SIGNS

10 bath

12 outlet of bath

14 inlet of bath

20 molten tin

30 molten glass

40 spout lip

50 heater

60 gas supply pipe

100 float glass

102 bottom surface

104 top surface

1. A float glass manufactured by causing a molten glass continuously supplied onto a molten tin in a bath to flow on the molten tin toward an outlet of the bath,
wherein, when a distance from a first surface which is one surface of both main surfaces of the float glass and is positioned on a side of the molten tin in the bath to an arbitrary position in a sheet thickness direction toward a second surface which is the other surface of the of the float glass is set to be x (μn), a function of a concentration of water (mass ppm) having x as a variable is set to be C(x), a distance between the both main surfaces of the float glass is set to be D (μm), a distance from the first surface to a position in which the concentration of water is maximum in the sheet thickness direction between the both main surfaces of the float glass is set to be Da (μm), and the concentration of water in the position of Da is set to be Ca (mass ppm),
the float glass satisfies the following formula (1):
$$\begin{matrix}[ Math . 1 ] & \\ \frac{{\int }_{0}^{Da} ( Ca - C ( x ) ) d x}{Ca \times D} \times 100 ≦ 0.5 . & ( 1 )\end{matrix}$$

2. The float glass according to claim 1, satisfying the following formula (2):
[Math. 2]
Ca≧470 (2)

3. A method for manufacturing a float glass, the method including causing a molten glass continuously supplied onto a molten tin in a bath to flow on the molten tin toward an outlet of the bath,
wherein an amount of water eluted from the molten glass to the molten tin in the bath is set to be 0.5% or lower of an amount of water in the molten glass immediately before flowing into the bath.

4. The method for manufacturing a float glass according to claim 3, wherein a temperature of the molten tin in the bath and/or a temperature of the molten glass in the bath is/are adjusted so that the amount of water eluted from the molten glass to the molten tin in the bath becomes 0.5% or lower of the amount of water in the molten glass immediately before flowing into the bath.

5. The method for manufacturing a float glass according to claim 3, wherein a concentration of hydrogen gas in an atmosphere inside the bath is adjusted so that the amount of water eluted from the molten glass to the molten tin in the bath becomes 0.5% or lower of the amount of water in the molten glass immediately before flowing into the bath.

6. The method for manufacturing a float glass according to claim 4, wherein a concentration of hydrogen gas in an atmosphere inside the bath is adjusted so that the amount of water eluted from the molten glass to the molten tin in the bath becomes 0.5% or lower of the amount of water in the molten glass immediately before flowing into the bath.

7. The method for manufacturing a float glass according to claim 3, wherein a concentration of water in the molten glass immediately before flowing into the bath is 470 mass ppm or more.

8. The method for manufacturing a float glass according to claim 4, wherein a concentration of water in the molten glass immediately before flowing into the bath is 470 mass ppm or more.

9. The method for manufacturing a float glass according to claim 5, wherein a concentration of water in the molten glass immediately before flowing into the bath is 470 mass ppm or more.

10. The method for manufacturing a float glass according to claim 6, wherein a concentration of water in the molten glass immediately before flowing into the bath is 470 mass ppm or more.
